(19) United States
(12) Patent Application Publication
(10) Pub. No.: US 2018/0306225 A1
(43) Pub. Date: Oct. 25, 2018

(54) Snap-in fastener for use in cabinet assembly

(71) Applicant: David Oliver Boone, Chesapeake, VA (US)

(72) Inventor: David Oliver Boone, Chesapeake, VA (US)

(21) Appl. No.: 15/955,269

(22) Filed: Apr. 17, 2018

Related U.S. Application Data
(60) Provisional application No. 62/488,007, filed on Apr. 20, 2017.

(51) Int. Cl. F16B 12/24; A47B 47/00; F16B 12/04

(52) U.S. Cl. CPC F16B 12/24; F16B 12/04; A47B 47/0075

(57) ABSTRACT

A system for snap-in fastening includes a first furniture member including snap-in dowels, each including a cut-out surface with ribs, an entry cut, a rear cut; a second furniture member with snap-in inserts, each including an entry opening and interior with ribs, such that the dowels insert into entry interiors to lock the first and second furniture members securely together with interlocking ribs.

### CROSS-REFERENCE TO RELATED APPLICATIONS

This U.S. Non-Provisional application claims the benefit of U.S. Provisional Application No. 62/488,007, filed Apr. 20, 2017; which is hereby included herein by reference in its entirety.

### FIELD OF THE INVENTION

The present invention relates generally to the field of cabinet and furniture construction, and more particularly to fastening devices, methods and systems for use in cabinet and furniture assembly.

### BACKGROUND OF THE INVENTION

Traditionally, some cabinets are assembled using dowels and glue, in a time consuming and expensive process that is not suitable for do-it-yourself users. Other modern manufacturing methods rely on cam connectors that, although simple in use, do not produce a stable fastening function, and generally will loosen significantly after shipping, disassembly, and reassembly. Other modern connectors may function well, but are complex and time consuming to manufacture.

As such, considering the foregoing, it may be appreciated that there continues to be a need for novel and improved devices and methods for fastening devices, methods and systems for use in cabinet and furniture assembly.

### SUMMARY OF THE INVENTION

The foregoing needs are met, to a great extent, by the present invention, wherein in aspects of this invention, enhancements are provided to the existing model of fastening systems and devices for assembly of cabinets and other furniture.

In an aspect, a system for snap-in fastening can include:
a) A first furniture member, which can be a first cabinet piece, such as a horizontal cabinet top/bottom, wherein the first furniture member includes:
   a plurality of snap-in dowels protruding from an end of the first furniture member; and
b) A second furniture member, which can be a second cabinet piece, such as a vertical cabinet side, wherein the second furniture member includes:
   a plurality of snap-in insert each inserted in inserts apertures that are positioned on an end of a side of the second furniture member;
   wherein the insert apertures can comprise overlapping first and second circular apertures, which can be of similar or different diameter, such as with the second circular aperture of substantially smaller diameter;
   wherein the snap-in inserts, are configured to be insertable into the insert apertures, the snap-in inserts each comprising an insert aperture, which connects to an insert interior;
   wherein the snap-in inserts can be substantially circular with a side protrusion, which serves to orient vertical alignment of the snap-in inserts;
   such that the first furniture member is attachable to the second furniture member by inserting each of the plurality of snap-in dowels through a corresponding entry aperture, such that it reaches into the corresponding insert interior of a corresponding snap-in insert, such that the snap-in dowels each slide into the corresponding insert interior, such that the dowels are each locked firmly in place inside a corresponding insert interior with interlocking serrated edges of the snap-in dowels and the insert interiors.
   whereby, the first furniture member is securely attached to the second furniture member.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a snap-in fastening system prior to assembly, according to an embodiment of the invention.

FIG. 2 is a perspective view of a snap-in fastening system after assembly, according to an embodiment of the invention.

FIG. 3A is a front top perspective view of a snap-in dowel of the snap-in fastening system, according to an embodiment of the invention.

FIG. 3B is a front bottom perspective view of a snap-in dowel of the snap-in fastening system, according to an embodiment of the invention.

FIG. 4A is a side view of a snap-in dowel of the snap-in fastening system, according to an embodiment of the invention.

FIG. 4B is a top view of a snap-in dowel of the snap-in fastening system, according to an embodiment of the invention.

FIG. 4C is a front view of a snap-in dowel of the snap-in fastening system, according to an embodiment of the invention.

FIG. 4D is a side view of a snap-in dowel of the snap-in fastening system, according to an embodiment of the invention.

FIG. 5A is a front view of an insert aperture of the snap-in fastening system, according to an embodiment of the invention.

FIG. 5B is a side view of an insert aperture of the snap-in fastening system, according to an embodiment of the invention.

FIG. 5C is a front view of an insert aperture of the snap-in fastening system, according to an embodiment of the invention.

FIG. 6A is a side view of a snap-in insert of the snap-in fastening system, according to an embodiment of the invention.

FIG. 6B is a top view of a snap-in insert of the snap-in fastening system, according to an embodiment of the invention.

FIG. 6C is a bottom perspective view of a snap-in insert of the snap-in fastening system, according to an embodiment of the invention.

FIG. 6D is a top perspective view of a snap-in insert of the snap-in fastening system, according to an embodiment of the invention.

FIG. 6E is a longitudinal cross-sectional view of part of a snap-in insert of the snap-in fastening system, according to an embodiment of the invention.

FIG. 7A is a lateral cross-sectional view of a snap-in insert of the snap-in fastening system, according to an embodiment of the invention.

FIG. 7B is a lateral cross-sectional view of a snap-in insert of the snap-in fastening system, according to an embodiment of the invention.

FIG. 7C is a lateral cross-sectional view of a snap-in insert of the snap-in fastening system, according to an embodiment of the invention.

FIG. 7D is a lateral cross-sectional view of a snap-in insert of the snap-in fastening system, according to an embodiment of the invention.

FIG. 8 is a front view of a snap-in insert of the snap-in fastening system, according to an embodiment of the invention.

FIG. 9 is a longitudinal cross-sectional view of a snap-in insert of the snap-in fastening system, according to an embodiment of the invention.

FIG. 10A is a top view of parts of a snap-in fastening system prior to shape manufacturing of snap-in dowels, according to an embodiment of the invention.

FIG. 10B is a top view of parts of a snap-in fastening system with snap-in dowels manufactured, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

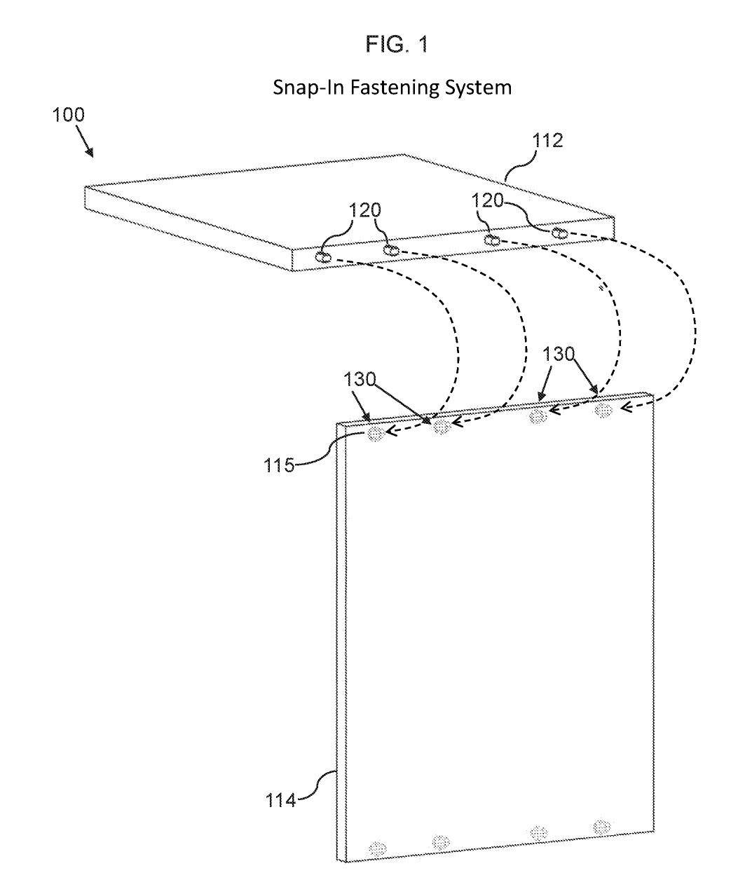

In the following, we describe the structure of an embodiment of a snap-in fastening system 100 for assembly of cabinets and other furniture with reference to FIG. 1, in such manner that like reference numerals refer to like components throughout; a convention that we shall employ for the remainder of this specification.

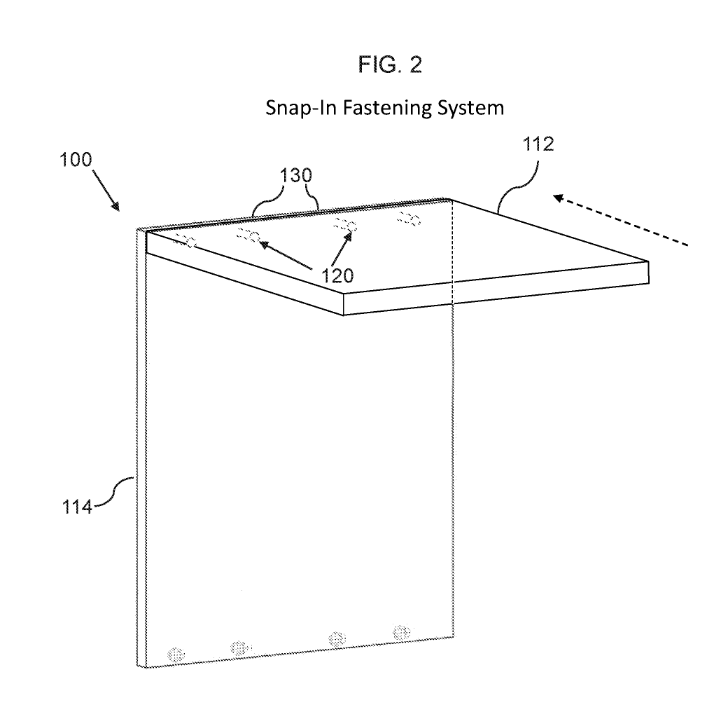

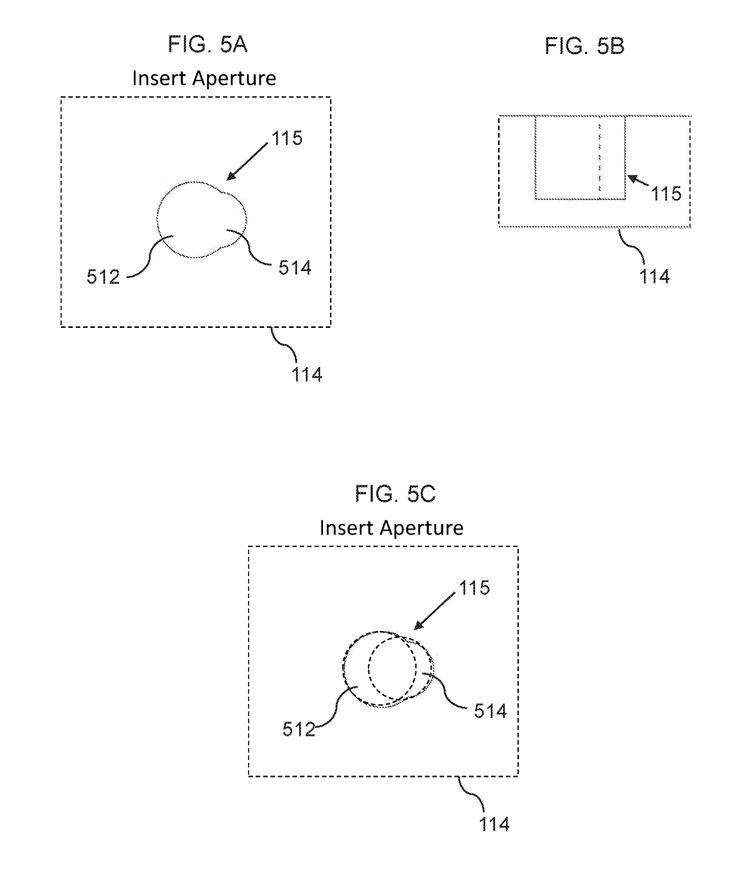

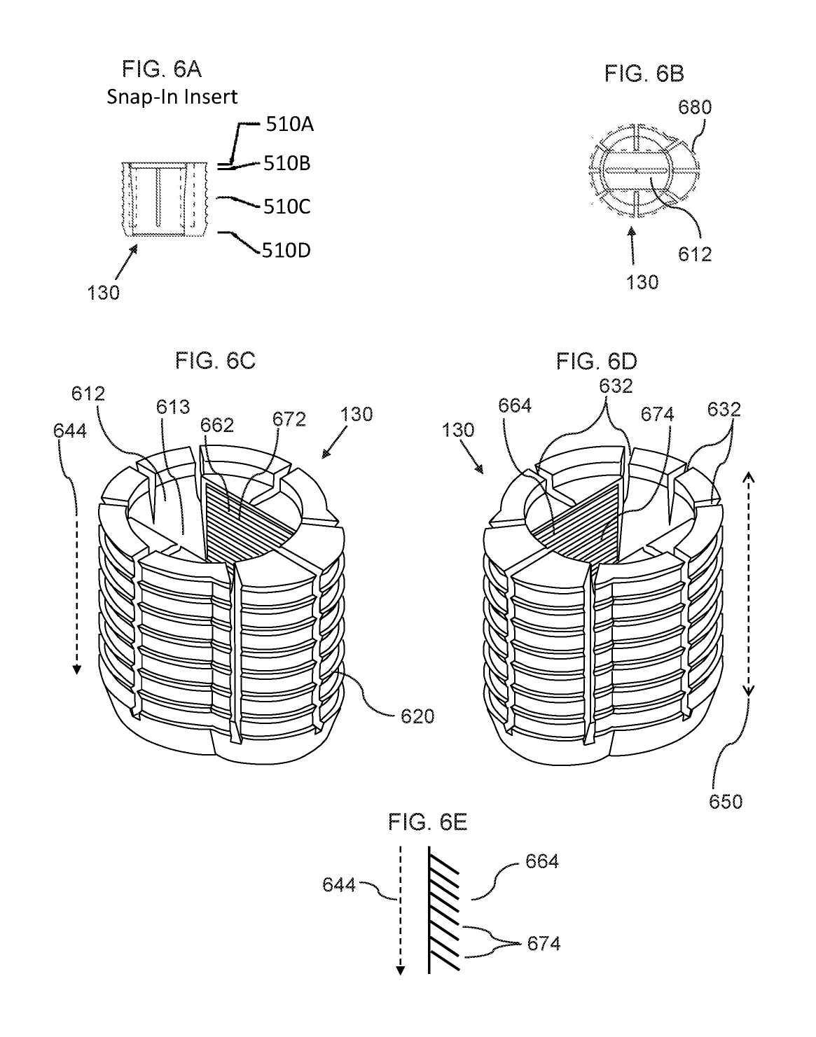

In an embodiment, a system for snap-in fastening 100 can include:
a) A first furniture member 112, which can be a first cabinet piece 112, such as a horizontal cabinet top/bottom 112, wherein the first furniture member 112 comprises:
   a plurality of snap-in dowels 120 protruding from an end of the first furniture member 112; and
b) A second furniture member 114, which can be a second cabinet piece 114, such as a vertical cabinet side 114, wherein the second furniture member 114 comprises:
   a plurality of snap-in insert 130 each inserted in inserts apertures 115 that are positioned on an end of a side of the second furniture member 114; and
   wherein the insert apertures 115, as shown in FIGS. 5A, 5B, and 5C, can comprise overlapping first and second circular apertures 512 514, which can be of similar or different diameter, such as shown with the second circular aperture 514 of substantially smaller diameter;
   wherein the snap-in inserts 130, as shown in FIGS. 6A, 6B, 6C, and 6D, are configured to be insertable into the insert apertures 115, shown in FIGS. 5A and 5B, the snap-in inserts 130 each comprising an entry aperture 612, which connects to an insert interior 613;
   wherein the snap-in inserts 130 can be substantially circular with a side protrusion 680, which serves to orient vertical alignment of the snap-in inserts 130;
   such that the first furniture member 112 is attachable to the second furniture member 114 by inserting each of the plurality of snap-in dowels 120 through a corresponding entry aperture 612, such that it reaches into the corresponding insert interior 613 of a corresponding snap-in insert 130, such that the snap-in dowels 120 each slide into the corresponding insert interior 613, such that the snap-in dowels 120 are each locked firmly in place inside a corresponding insert interior 613;
   whereby, as shown in FIG. 2, the first furniture member 112 is securely attached to the second furniture member 114.

In related embodiments, the first and second furniture members 112 114 can be perpendicularly connected, such as shown in FIG. 2.

In related embodiments, the insert apertures 115, as shown in FIG. 5A, can be associated with a method of creating an elongated aperture, by drilling two intersecting/overlapping holes 512 514. The insert apertures 115 can thereby accommodate inserts of varying designs (i.e. be used for inserts other than the snap-in insert 130), which can be inserted with a well-defined vertical alignment.

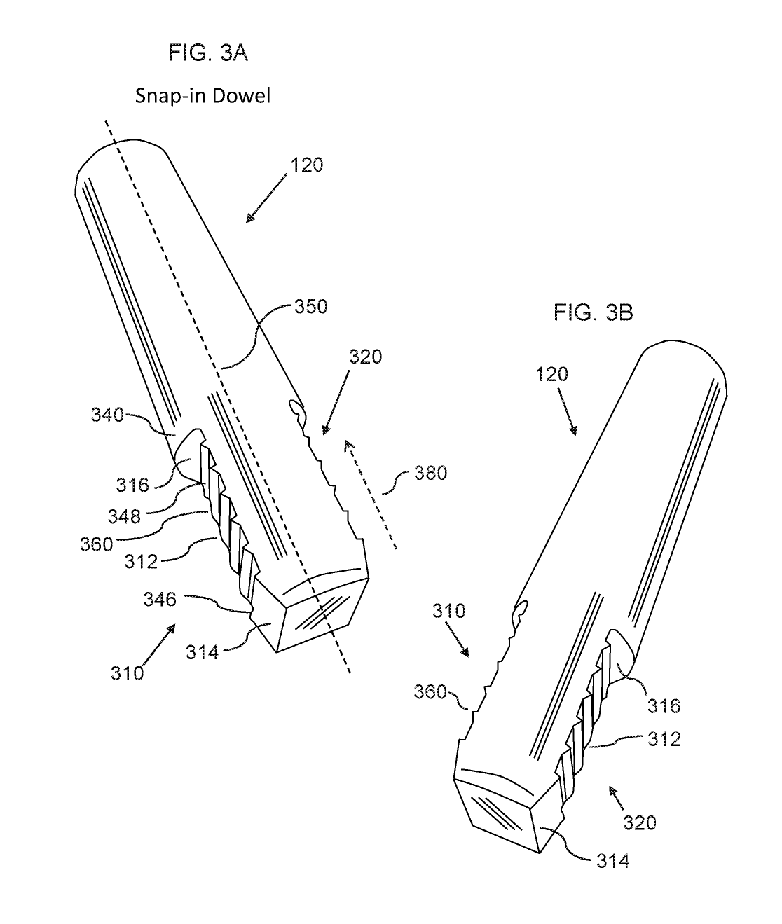

In a related embodiment, as shown in FIGS. 3A and 3B, a snap-in dowel 120 can be configured as a cylindrical member including a top front cutout 310 and a bottom front cutout 320, each comprising:
a) a cutout surface 312, such that the snap-in dowel 120 has a uniform width from a front 346 of the cutout surface 312 to a rear 348 of the cutout surface 312, wherein the cutout surface 312 further comprises:
   i. a plurality of dowel ribs 360, which can be rearward 380 pointing, which are configured to aid in locking the snap-in dowel 120 in place inside a snap-in insert 130, such that the rearward 380 pointing dowel ribs 360 interlock with inward 644 pointing inner ribbed edges 672 674 of the snap-in insert 130 (i.e the rearward 380 pointing dowel ribs 360 can also be referred to as outward 380 pointing in relation to the inward 644 pointing inner ribbed edges 672 674). The dowel ribs 360 can also be referred to as dowel serrated edges 360, or dowel ribbed edges 360;
b) an entry cut 314, which is a front cut that connects with a front of the cutout surface 312, such that the entry cut 314 is configured to ease insertion of the snap-in dowel 120; and
c) a rear cut 316, which connects with a rear of the cutout surface 312 to reach the rear surface 340 of the
wherein the top and bottom front cutouts 310 320 are symmetrical around a center axis 350 of the snap-in dowel.

In a further related embodiment, the snap-in dowel 120 can be up-down asymmetrical, comprising only one of a top front cutout 310 or a bottom front cutout 320, such that an opposite side to the top front cutout 310 or bottom front cutout 320 is an unmodified rounded/cylindrical dowel surface.

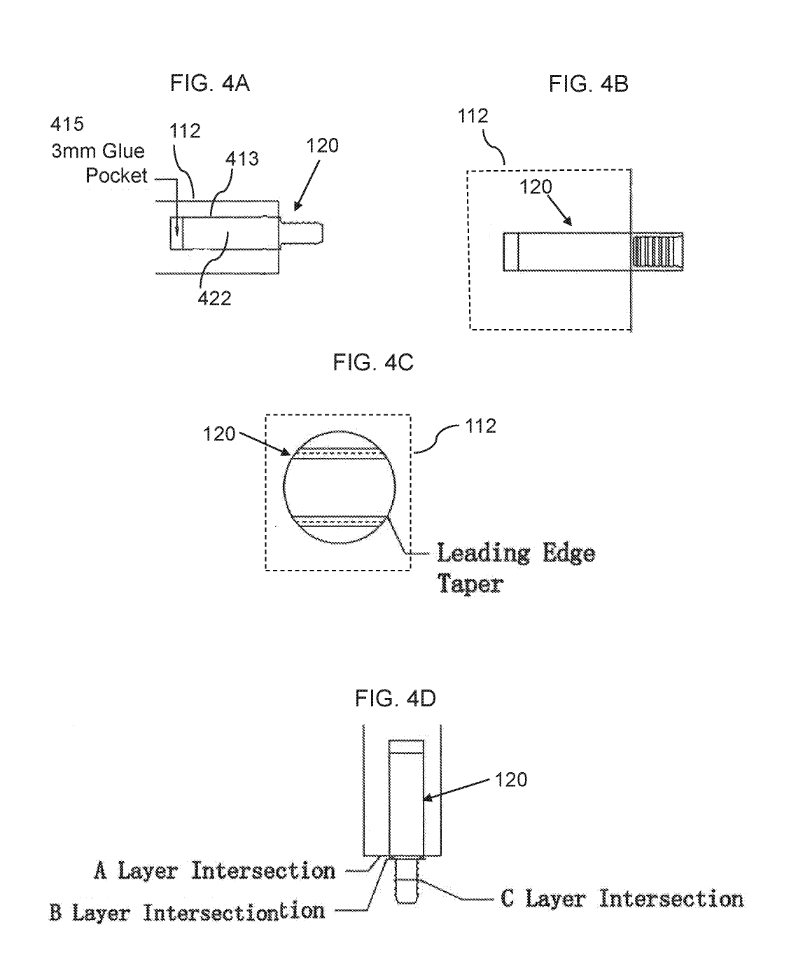

In a related embodiment, as shown in FIG. 4A, a rear end 422 of the snap-in dowel 120 can be permanently connected to by insertion of the rear end 422 into a predrilled aperture 413 of the first furniture member 112, with a glue pocket/deposit 415 inserted in a bottom of the predrilled aperture. FIGS. 4B and 4C show respectively top and front views of the snap-in dowel 120.

In a related embodiment, FIG. 4D shows a side view of the uniform vertical width of the front of the snap-in dowel 120 between the top and bottom front cutouts 310 320.

In a related embodiment, as shown in FIGS. 6C and 6D, the snap-in insert 130 can have outer serrated edges 620, which can also be referred to as outer ribbed edges 620, on sides of the snap-in insert 130, such that the outer serrated edges 620 help secure the snap-in insert 130 inside the insert aperture 115. Further the top and bottom sides 662 664 of the insert interior can be lined with top and bottom inner serrated edges 672 674, which can also be referred to as top and bottom inner ribbed edges 672 674, which can be configured to be inward 644 pointing, as shown in FIGS. 6C, 6D, and 6E.

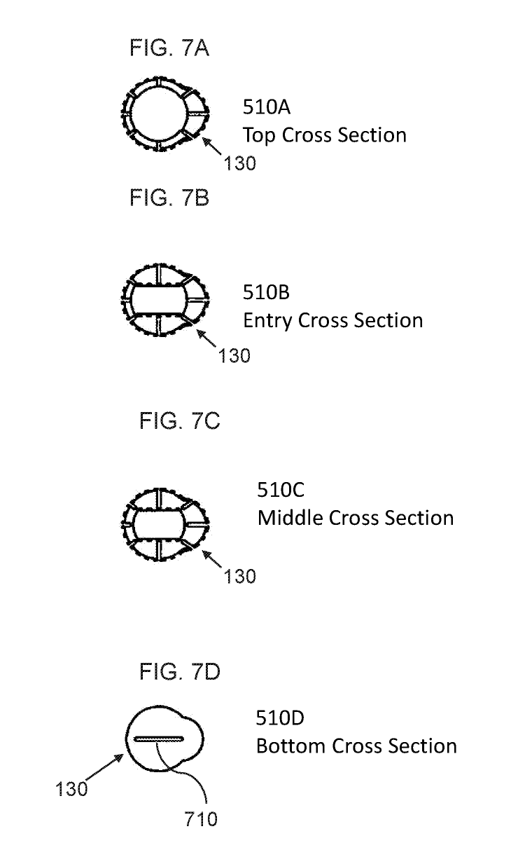

In a related embodiment, FIG. 6A in conjunction with FIGS. 7A, 7B, 7C, and 7D show, in lateral sectional cuts, that the insert interior has uniform width, from an entry cross section 510B, shown in FIGS. 6A and 7B, through a middle cross section 510C, shown in FIGS. 6A and 7D, such that the shape of a front end of a snap-in dowel 120 with top front cutout 310 and a bottom front cutout 320 is configured to match with the shape of the insert interior, such that when the snap-in dowel is into the insert interior 613, rearward/outward 380 pointing dowel ribs 360 of the snap-in dowel 120 will engage/interlock with inward 644 pointing inner serrated edges 672 674, whereby the snap-in dowel 120 is securely and tightly locked into the insert interior 613. The secure and tight fit of a plurality of snap-in dowels 120 will thereby ensure that the first and second furniture members 112 114 are pulled tightly and securely together, as shown in FIG. 2. Additionally, FIGS. 6A and 7A show the top cross section 510A, and FIGS. 6A and 7D show the bottom cross section 510D.

In a further related embodiment, as shown in FIG. 7D, showing the bottom cross section 510D, a bottom of the insert interior 613 can include a bottom elongated guide protrusion 710, which is configured to adjust a position of the snap-in dowel 120 and ensure that the snap-in dowel 120 can be moved into the insert interior 613 with minimal friction. In some embodiments, the insert interior 613 may not have a bottom, such that the insert interior 613 protrudes through the slide-in insert 130.

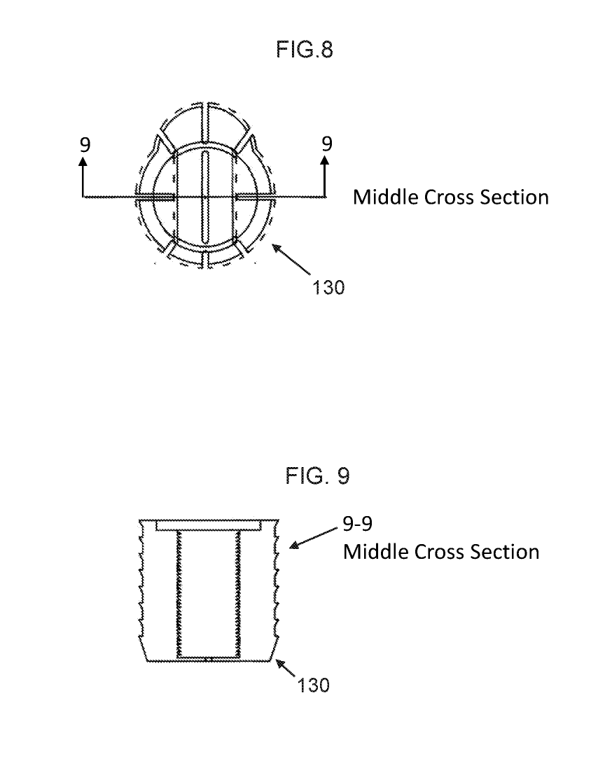

In a related embodiment, FIGS. 8 and 9 show in a longitudinal sectional cut 9-9 that the insert interior 613 is configured with a uniform width between top and bottom sides of the insert interior 613. Other sizing can be applied, the specific dimensions provided here are merely exemplary.

In a further related embodiment, the insert interior 613 can be configured with a size that matches the snap-in dowels 120, such that the snap-in insert 130 expands slightly when the snap-in dowels 120 is pushed into the insert interior 613, whereby the snap-in insert 130 is further secured inside the insert aperture 115, as the outer serrated edges expand into sides of the insert apertures 115. The snap-in insert 130 expands throughout the entire length 650 of the snap-in insert 130.

In a yet further related embodiment, the snap-in insert 130 can further include expansion slits 632 on an outer surface of the snap-in insert 130. The expansion slits 632 can be located to control the expanding portions of the snap-in insert 130, such that omission of expansion slits 632 can ensure a substrate 114 is only compressed in areas of sufficient strength.

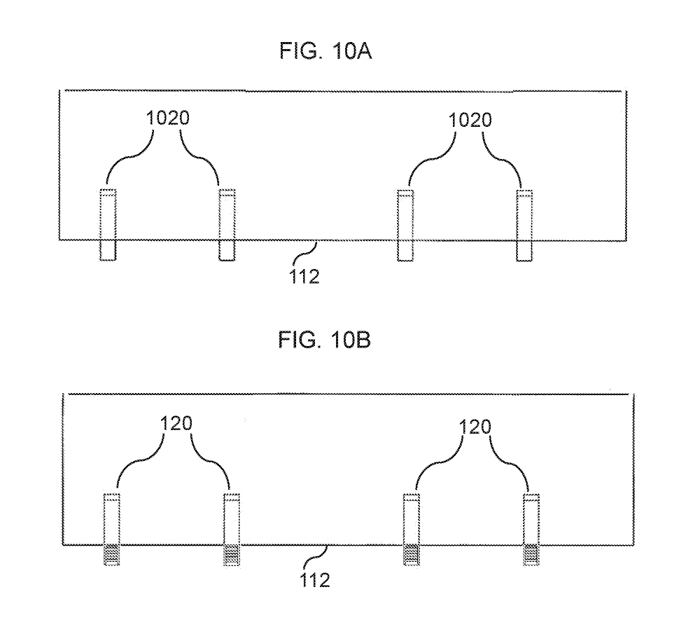

In a related embodiment, as shown in FIGS. 10A and 10B, a method of manufacturing snap-in dowels 120, can comprise:
a) Inserting dowels 1020 into a furniture member 112, wherein the dowels 1020 are conventional dowels, shaped as solid cylindrical rods, for example made of wood or plastic, such that the dowels 1020 are glued into predrilled apertures, as shown in FIG. 10A;
b) Machining the exposed end of the dowels 1020, to create the top front cutout 310 and a bottom front cutout 320, for example using a cutting or grinding tool, such that the dowels 1020 are transformed to snap-in dowels 120, as shown in FIG. 10B.

In various related embodiments, the system for snap-in fastening 100 can:
a) Allow machining/shaping of round dowels 1020 after dowels 1020 are inserted into host material for the purpose of creating precision parallel or perpendicular alignment and precise machining characteristics relative to host material;
b) Create significant compression and prohibit perpendicular pullout due to interlocking serrated edges 672 674 of the snap-in insert 130;
c) Allow glue-less assembly of products, without use screws and/or CNC Routers
d) Allow compression connectors to be hidden without use of CNC routers

Here has thus been described a multitude of embodiments of the system for snap-in fastening 100, and devices and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for snap-in fastening, comprising:
a) a first furniture member, comprising:
a plurality of snap-in dowels protruding from an end of the first furniture member; and
b) a second furniture member, comprising:
a plurality of insert apertures, which are positioned on an end of a side of the second furniture member; and
a plurality of snap-in inserts, each comprising an entry aperture and an insert interior that is accessible via the entry aperture, wherein each snap-in insert is configured to be insertable in a corresponding insert aperture in the plurality of insert apertures; and
such that the first furniture member is attachable to the second furniture member by inserting each snap-in dowel of the plurality of snap-in dowels through a corresponding entry aperture, such that a corresponding snap-in dowel reaches into a corresponding insert interior of a corresponding snap-in insert, such that the corresponding snap-in dowel is locked firmly in place inside the corresponding insert interior;
whereby the first furniture member is securely attached to the second furniture member.

2. The system for snap-in fastening of claim 1, wherein each insert aperture comprises overlapping first and second circular apertures.

3. The system for snap-in fastening of claim 2, wherein a diameter of the first circular aperture is larger than a diameter of the second circular aperture;
wherein each snap-in insert is substantially circular with a side protrusion, which serves to orient vertical alignment of the snap-in inserts.

4. The system for snap-in fastening of claim 1, wherein the first and second furniture members are perpendicularly connected.

5. The system for snap-in fastening of claim 1, wherein each snap-in dowel is configured as a cylindrical member, which comprises a top front cutout and a bottom front cutout, each of the top and bottom front cutouts comprising:
a cutout surface, such that the corresponding snap-in dowel is configured with a uniform width from a front of the cutout surface to a rear of the cutout surface;
such that each snap-in dowel is configured with a uniform vertical width of a front of each snap-in dowel between the top and bottom front cutouts.

6. The system for snap-in fastening of claim 5, wherein the cutout surface further comprises a plurality of dowel ribs, which are configured to aid in locking the snap-in dowel in place inside a snap-in insert.

7. The system for snap-in fastening of claim 6, wherein the dowel ribs are configured to be rearward pointing.

8. The system for snap-in fastening of claim 6, wherein each of the top and bottom front cutouts further comprise:
a) an entry cut, which is a front cut that connects with a front of the cutout surface, such that the entry cut is configured to ease insertion of the snap-in dowel; and
b) a rear cut, which connects with a rear of the cutout surface to reach the rear surface of the snap-in dowel.

9. The system for snap-in fastening of claim 1, wherein each snap-in dowel is configured as a cylindrical member, which comprises solely one cutout, comprising:
a cutout surface, such that the corresponding snap-in dowel is configured with a uniform width from a front of the cutout surface to a rear of the cutout surface.

10. The system for snap-in fastening of claim 1, wherein the first furniture member further comprises:
predrilled apertures with glue deposits in bottoms of the predrilled apertures;
wherein rear ends of the snap-in dowels each are permanently connected to the first furniture member, by insertion of the rear ends into the predrilled apertures with the glue deposits.

11. The system for snap-in fastening of claim 1, wherein the corresponding snap-in insert is configured with outer ribbed edges, such that the outer ribbed edges are configured to secure the corresponding snap-in insert inside the corresponding insert aperture.

12. The system for snap-in fastening of claim 7, wherein the top and bottom sides of the insert interior are lined with respectively top and bottom inner ribbed edges.

13. The system for snap-in fastening of claim 12, wherein the inner ribbed edges are configured to be inward pointing;
such that the inward pointing inner ribbed edges are configured to interlock with the rearward pointing dowel ribs.

14. The system for snap-in fastening of claim 1, wherein the insert interior further comprises a bottom, which further comprises a bottom elongated guide protrusion, which is configured to adjust a position of the corresponding snap-in dowel and ensure that the corresponding snap-in dowel is moveable into the corresponding insert interior with minimal friction.

15. The system for snap-in fastening of claim 11, wherein the corresponding insert interior is configured with a size that matches the snap-in dowels, such that the corresponding snap-in insert is configured to expand when the corresponding snap-in dowel is pushed into the corresponding insert interior, whereby the corresponding snap-in insert is further secured inside the corresponding insert aperture, as the outer ribbed edges expand into sides of the corresponding insert aperture, along a length of the corresponding snap-in insert.

16. The system for snap-in fastening of claim 15, wherein the corresponding snap-in insert further comprises a plurality of expansion slits on an outer surface of the corresponding snap-in insert.

17. A system for snap-in fastening, comprising:
a) a plurality of snap-in dowels configured to protrude from an end of a first furniture member; and
b) a plurality of snap-in inserts, each comprising an entry aperture and an insert interior that is accessible via the entry aperture, wherein each snap-in insert is configured to be insertable in a corresponding insert aperture in a plurality of insert apertures, which are positioned on an end of a side of a second furniture member;
such that the first furniture member is attachable to the second furniture member by inserting each snap-in dowel of the plurality of snap-in dowels through a corresponding entry aperture, such that a corresponding snap-in dowel reaches into a corresponding insert interior of a corresponding snap-in insert, such that the corresponding snap-in dowel is locked firmly in place inside the corresponding insert interior;
whereby the first furniture member is securely attached to the second furniture member.

18. A method of manufacturing snap-in dowels, comprising:
a) inserting cylindrical dowels into predrilled apertures of a furniture member, wherein the predrilled apertures are filled with glue, such that the cylindrical dowels are glued into the predrilled apertures; and
b) machining exposed ends of the cylindrical dowels, to create for each cylindrical dowel a top front cutout and a bottom front cutout, such that the cylindrical dowels are transformed to snap-in dowels.

19. The method of manufacturing snap-in dowels of claim 18, wherein for each snap-in dowel, each of the top and bottom front cutouts are machined to comprise:
a cutout surface, such that each snap-in dowel is configured with a uniform width from a front of the cutout surface to a rear of the cutout surface;
wherein the top and bottom front cutouts are symmetrical around a center axis of each snap-in dowel;
wherein each snap-in dowel is configured with a uniform vertical width of the front of each snap-in dowel between the top and bottom front cutouts.

20. The method of manufacturing snap-in dowels of claim 19, wherein each of the top and bottom front cutouts are machined to further comprise:
a) an entry cut, which is a front cut that connects with a front of the cutout surface, such that the entry cut is configured to ease insertion of the snap-in dowels; and
b) a rear cut, which connects with a rear of the cutout surface to reach the rear surface of the snap-in dowels.

21. The method of manufacturing snap-in dowels of claim 19, wherein the cutout surface is machined to further comprise a plurality of rearward pointing dowel ribs, which are configured to aid in locking the snap-in dowel in place inside a snap-in insert.
